(19) United States
(12) Patent Application Publication
(10) Pub. No.: US 2025/0323883 A1
(43) Pub. Date: Oct. 16, 2025

(54) TECHNIQUES FOR AN ARTIFICIAL INTELLIGENCE ASSISTANT FOR FAMILY HISTORY AND STORYTELLING

(71) Applicant: World Archives Holdings, LLC, Provo, UT (US)

(72) Inventors: Benjamin Whitcomb Cook, New York City, NY (US); Nicolas Andre Bonifas, New Haven, CT (US); Darren McAuliffe, Austin, TX (US); Barry Steven Watson, JR., Coral Springs, FL (US); Kendall Hulet, Provo, UT (US); Chris Bradford, Pleasant Grove, UT (US); Laryn Brown, Cedar Hills, UT (US)

(21) Appl. No.: 19/176,100

(22) Filed: Apr. 10, 2025

Related U.S. Application Data
(60) Provisional application No. 63/632,457, filed on Apr. 10, 2024.
(60) Provisional application No. 63/768,090, filed on Mar. 6, 2025.

(51) Int. Cl. H04L 51/02

(52) U.S. Cl. CPC H04L 51/02

(57) ABSTRACT

Techniques for an AI assistant for family history and storytelling is disclosed. An apparatus is configured to present an initial prompt to a user, receive a response to the prompt from the user, generate one or more additional prompts based on the response to create a conversation with the user using an artificial intelligence engine, and generate contextual information based on responses to the one or more additional prompts using the artificial intelligence engine.

### CROSS-REFERENCES TO RELATED APPLICATIONS

This application claims the benefit of U.S. Provisional Patent Application No. 63/632,457 entitled “AI-Assisted Biographical Interview System and Method” and filed on Apr. 10, 2024, for Dr. Nicolas Andre Bonifas, and U.S. Provisional Patent Application No. 63/768,090 entitled “TECHNIQUES FOR AN ARTIFICIAL INTELLIGENCE ASSISTANT FOR FAMILY HISTORY AND STORYTELLING” and filed on Mar. 6, 2025, for Kendall Hulet, which are incorporated herein by reference.

### FIELD

This invention relates to genealogy and more particularly relates to techniques for an artificial intelligence (AI) assistant for family history and storytelling.

### BACKGROUND

Genealogy is the study of family history and lineage, tracing the ancestry and descent of individuals or families. It involves researching historical records, DNA analysis, and oral histories to map out family trees and understand relationships over generations. However, details and stories about relationships, events, etc. can be lost if not documented during a person's lifetime.

### SUMMARY

An apparatus for an AI assistant for family history and storytelling is disclosed. A computer program product and method also perform the functions of the apparatus.

In one embodiment, an apparatus is configured to present an initial prompt to a user, receive a response to the prompt from the user, generate one or more additional prompts based on the response to create a conversation with the user using an artificial intelligence engine, and generate contextual information based on responses to the one or more additional prompts using the artificial intelligence engine.

In one embodiment, the response is an audio response and the at least one processor is configured to cause the apparatus to transcribe the audio response prior to providing it to the artificial intelligence engine. In one embodiment, the apparatus is configured to present a plurality of predefined prompts and receive a selection of the initial prompt from the plurality of predefined prompts.

In one embodiment, the initial prompt is a user-generated prompt. In one embodiment, the user-generated prompt is based on information from the user or from a different user associated with the user, or a combination thereof. In one embodiment, the initial prompt is generated by the artificial intelligence engine based on previous responses and contextual information associated with the user.

In one embodiment, the contextual information comprises a story, a summary, an outline, a title, commentary, or a combination thereof that the artificial intelligence engine generates based on responses to the initial prompt and the one or more additional prompts. In one embodiment, the apparatus is configured to identify people, places, events, dates, or a combination thereof associated with the responses.

In one embodiment, the apparatus is configured to generate the one or more additional prompts based on a conversation theme and to guide the conversation toward the conversation theme. In one embodiment, the apparatus is configured to receive an image and generate one or more prompts related to the image using the artificial intelligence engine.

In one embodiment, the apparatus is configured to identify third-party contextual information from one or more third party sources, integrate the third-party contextual information into the contextual information, and use the third-party contextual information to generate the one or more additional prompts. In one embodiment, the apparatus is configured to extract contextual information from one or more other users associated with the user.

In one embodiment, the artificial intelligence engine comprises a generative artificial intelligence engine. In one embodiment, the apparatus is configured to continuously retrain the artificial intelligence engine based on the responses and contextual information.

In one embodiment, a method is configured to present an initial prompt to a user, receive a response to the prompt from the user, generate one or more additional prompts based on the response to create a conversation with the user using an artificial intelligence engine, and generate contextual information based on responses to the one or more additional prompts using the artificial intelligence engine.

In one embodiment, a computer program product is configured to is configured to present an initial prompt to a user, receive a response to the prompt from the user, generate one or more additional prompts based on the response to create a conversation with the user using an artificial intelligence engine, and generate contextual information based on responses to the one or more additional prompts using the artificial intelligence engine.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a schematic block diagram illustrating one embodiment of a system for techniques for an AI assistant for family history and storytelling, in accordance with the subject matter disclosed herein;

FIG. 2 depicts one embodiment of an apparatus for techniques for an AI assistant for family history and storytelling in accordance with the subject matter disclosed herein;

FIG. 3 is a schematic flow chart diagram illustrating one embodiment of a method for techniques for an AI assistant for family history and storytelling, in accordance with the subject matter disclosed herein; and

FIG. 4 is a schematic flow chart diagram illustrating one embodiment of a method for techniques for an AI assistant for family history and storytelling, in accordance with the subject matter disclosed herein.

### DETAILED DESCRIPTION

The subject matter herein is directed to techniques for an artificial intelligence (AI) assistant for family history and storytelling. In some configurations, the subject matter herein utilizes an interactive question and response loop designed to interactively and dynamically generate follow-up questions based on user responses with respect to at least some previous system-generated questions, to collect raw audio data from users that can be used to generate stories based on the user's recordings. The subject matter herein analyzes the content of the stories with respect to user data, inputs, and other information associated with the user, to create summaries and biographies which may be organized in multiple different ways, such as by themes.

The AI-assisted interviewer goes beyond what could be accomplished by an unassisted human or existing AI technologies. For users, the experience is seamless—they simply talk into the microphone, answer thought-provoking questions responding to prompts that are enhanced by the complete dataset available to the system, and see their recordings transformed into well-written, fully developed stories and related outputs.

Not everyone is a writer, but everyone has a story. By engaging in this comprehensive AI-assisted interview process, the experience can be emotional for users in a way that far surpasses the limitations of what was previously possible using human interviewers. Conventional solutions that generate questions or write stories based on audio recording transcripts cannot do more than describe what the user has inputted. The subject matter herein, however, transforms simple interview conversations into rich biographical output using sophisticated AI.

The subject matter herein relates to an AI-assisted biographical interviewer, platform, architecture, or the like for conducting biographical interviews, enabling users to record their life stories, experiences, and memories in an interactive and engaging manner. The subject matter herein employs artificial intelligence and natural language processing techniques to generate personalized follow-up questions, analyze user responses, and create comprehensive story summaries and memoirs.

The subject matter herein allows users to select an initial prompt from a predefined set or enter their own custom prompt. Users can then record their audio responses to the prompt, which may be transcribed using speech-to-text transcription algorithms. The transcribed information may be analyzed using various processes such as natural language processing techniques configured to extract key information about the user's life and the story in question.

Such information can then be used to generate engaging and contextually relevant follow-up questions, in addition to a range of additional AI outputs and applications. Outputs include generating summaries, story titles, conversational commentary, longform biography content such as books in the style of a memoir, shorter written output in the style of an encyclopedia entry, data entries to update existing databases including in formats like family trees or other genealogical applications.

The subject matter herein draws from a range of natural language processing techniques and models, which work collaboratively to help the user capture the desired data. In one configuration, the subject matter herein uses an iterative process to select the most appropriate questions from a variety of, e.g., Large Language Model-generated follow-up questions based on the content and context of the user's responses.

The subject matter herein also supports multimedia content, allowing users to attach photos, videos, and documents to their stories. A multimodal transformer architecture is employed to generate photo-specific prompts, encouraging users to provide more context and details about the images they share. The transformer takes into account the visual features of the photo and any surrounding text to generate relevant and engaging prompts.

In some scenarios, the subject matter herein may additionally enhance the interview experience by conducting searches, e.g., Internet searches, genealogy searches, or the like, to identify additional information available from within a user's own existing biographical or genealogical datasets. These and other data connections can then be used to inform relevant follow-up questions or AI-generated outputs that go beyond what a human interviewer can generate. For example, a historical family photo might contain certain elements that could be used to identify dates, individuals, or the particular setting or circumstances of the picture, providing context and suggestions that could help users fill in details to gather a more complete record of family history than would be possible otherwise.

The system employs advanced security and privacy measures to protect the integrity of the interaction data and the privacy of the users, including data encryption, access controls, and compliance with relevant data protection regulations. The system is additionally improved continuously by training on user engagement.

There are various different potential applications for solutions described herein. For instance, for personal history preservation, the AI-assisted biographical interviewer provides a convenient and engaging way for individuals to record and preserve their life stories, memories, wisdom, and experiences. By guiding users through the process of sharing their stories, the system helps create a lasting legacy that can be passed down to future generations.

In another embodiment, the AI-assisted biographical interviewer can serve as a valuable tool for individuals interested in writing their autobiographies or memoirs. The summaries and biographies that are generated can provide a structured foundation and inspiration for users to further develop and refine their personal life stories.

In another embodiment, the AI-assisted biographical interviewer can be used to capture and preserve family histories and genealogical information. Family members can use the platform to record their individual stories, which can then be combined to create a comprehensive family history that can be preserved for future generations, shared with living relatives, and queried by interested individuals to learn more about the experiences of their family and friends. The collaboration feature allows multiple family or community members to contribute and share their memories, providing a rich tapestry of human experiences.

In yet another embodiment, the AI-assisted biographical interviewer can generate prompts and questions that encourage users to share stories and experiences from different generational perspectives and about different members of their extended network of relatives and associates. For example, it can leverage or enhance existing family tree ancestry data by asking users to describe their grandparents' lives, their parents' experiences, or their own childhood memories. This can help capture the evolution of family narratives, highlighting the societal changes and personal adaptations across generations.

In another embodiment, by analyzing the stories shared by different family members across generations, the system can identify common themes, shared experiences, or recurring narratives. It can highlight these connections and suggest related stories from other family members, fostering a sense of continuity and understanding within the family. The data this system collects will be uniquely interesting to relatives, descendants, friends, other loved ones and even historians for decades to come.

In another embodiment, the AI-assisted biographical interviewer can be utilized by cultural institutions, such as museums, libraries, and archives, to document and preserve the stories and experiences of individuals from diverse communities. By collecting and curating these personal narratives, cultural institutions can create rich and inclusive collections that reflect the diversity of human experiences and contribute to the preservation of cultural heritage.

In another embodiment, the AI-assisted biographical interviewer can be used to document memorable moments or the day-to-day experiences of new parents, and to produce outputs such as baby photo books captioned with AI-generated stories from the early experiences and reflections of the family, or multimedia digital assets that can be shared with loved ones in real time or preserved for future viewing.

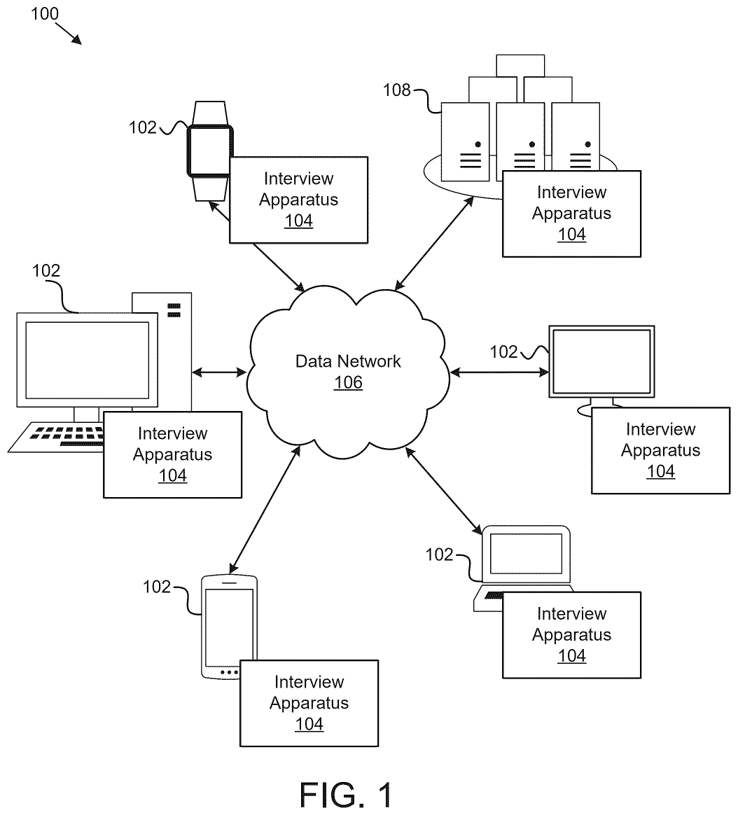

FIG. 1 is a schematic block diagram illustrating one embodiment of a system for techniques for an AI assistant for family history and storytelling, in accordance with the subject matter disclosed herein. In one embodiment, the system 100 includes one or more information handling devices 102, one or more interview apparatuses 104, one or more data networks 106, and one or more servers 108. In certain embodiments, even though a specific number of information handling devices 102, interview apparatuses 104, data networks 106, and servers 108 are depicted in FIG. 1, one of skill in the art will recognize, in light of this disclosure, that any number of information handling devices 102, interview apparatuses 104, data networks 106, and servers 108 may be included in the system 100.

In one embodiment, the system 100 includes one or more information handling devices 102. The information handling devices 102 may be embodied as one or more of a desktop computer, a laptop computer, a tablet computer, a smart phone, a smart speaker (e.g., Amazon Echo®, Google Home®, Apple HomePod®), an Internet of Things device, a security system, a set-top box, a gaming console, a smart TV, a smart watch, a fitness band or other wearable activity tracking device, an optical head-mounted display (e.g., a virtual reality headset, smart glasses, head phones, or the like), a High-Definition Multimedia Interface (“HDMI”) or other electronic display dongle, a personal digital assistant, a digital camera, a video camera, or another computing device comprising a processor (e.g., a central processing unit (“CPU”), a processor core, a field programmable gate array (“FPGA”) or other programmable logic, an application specific integrated circuit (“ASIC”), a controller, a microcontroller, and/or another semiconductor integrated circuit device), a volatile memory, and/or a non-volatile storage medium, a display, a connection to a display, and/or the like.

In general, in one embodiment, the interview apparatus 104 is configured to create an AI interviewer that guides users through the initial steps of building a family tree and other key relationships through natural conversation, and generate stories, biographics, documentaries, summaries, and/or the like about the user and the user's relationships. The interview apparatus 104, in one embodiment, presents an initial prompt to a user, receives a response to the prompt from the user, generates one or more additional prompts based on the response to create a conversation with the user using an artificial intelligence engine, and generates contextual information based on responses to the one or more additional prompts using the artificial intelligence engine.

In certain embodiments, the interview apparatus 104 may include a hardware device such as a secure hardware dongle or other hardware appliance device (e.g., a set-top box, a network appliance, or the like) that attaches to a device such as a head mounted display, a laptop computer, a server 108, a tablet computer, a smart phone, a security system, a network router or switch, or the like, either by a wired connection (e.g., a universal serial bus (“USB”) connection) or a wireless connection (e.g., Bluetooth®, Wi-Fi, near-field communication (“NFC”), or the like); that attaches to an electronic display device (e.g., a television or monitor using an HDMI port, a DisplayPort port, a Mini DisplayPort port, VGA port, DVI port, or the like); and/or the like. A hardware appliance of the interview apparatus 104 may include a power interface, a wired and/or wireless network interface, a graphical interface that attaches to a display, and/or a semiconductor integrated circuit device as described below, configured to perform the functions described herein with regard to the interview apparatus 104.

The interview apparatus 104, in such an embodiment, may include a semiconductor integrated circuit device (e.g., one or more chips, die, or other discrete logic hardware), or the like, such as a field-programmable gate array (“FPGA”) or other programmable logic, firmware for an FPGA or other programmable logic, microcode for execution on a microcontroller, an application-specific integrated circuit (“ASIC”), a processor, a processor core, or the like. In one embodiment, the interview apparatus 104 may be mounted on a printed circuit board with one or more electrical lines or connections (e.g., to volatile memory, a non-volatile storage medium, a network interface, a peripheral device, a graphical/display interface, or the like). The hardware appliance may include one or more pins, pads, or other electrical connections configured to send and receive data (e.g., in communication with one or more electrical lines of a printed circuit board or the like), and one or more hardware circuits and/or other electrical circuits configured to perform various functions of the interview apparatus 104.

The semiconductor integrated circuit device or other hardware appliance of the interview apparatus 104, in certain embodiments, includes and/or is communicatively coupled to one or more volatile memory media, which may include but is not limited to random access memory (“RAM”), dynamic RAM (“DRAM”), cache, or the like. In one embodiment, the semiconductor integrated circuit device or other hardware appliance of the interview apparatus 104 includes and/or is communicatively coupled to one or more non-volatile memory media, which may include but is not limited to: NAND flash memory, NOR flash memory, nano random access memory (nano RAM or “NRAM”), nanocrystal wire-based memory, silicon-oxide based sub-10 nanometer process memory, graphene memory, Silicon-Oxide-Nitride-Oxide-Silicon (“SONOS”), resistive RAM (“RRAM”), programmable metallization cell (“PMC”), conductive-bridging RAM (“CBRAM”), magneto-resistive RAM (“MRAM”), dynamic RAM (“DRAM”), phase change RAM (“PRAM” or “PCM”), magnetic storage media (e.g., hard disk, tape), optical storage media, or the like.

The data network 106, in one embodiment, includes a digital communication network that transmits digital communications. The data network 106 may include a wireless network, such as a wireless cellular network, a local wireless network, such as a Wi-Fi network, a Bluetooth® network, a near-field communication (“NFC”) network, an ad hoc network, and/or the like. The data network 106 may include a wide area network (“WAN”), a storage area network (“SAN”), a local area network (“LAN”) (e.g., a home network), an optical fiber network, the internet, or other digital communication network. The data network 106 may include two or more networks. The data network 106 may include one or more servers, routers, switches, and/or other networking equipment. The data network 106 may also include one or more computer readable storage media, such as a hard disk drive, an optical drive, non-volatile memory, RAM, or the like.

The wireless connection may be a mobile telephone network. The wireless connection may also employ a Wi-Fi network based on any one of the Institute of Electrical and Electronics Engineers (“IEEE”) 802.11 standards. Alternatively, the wireless connection may be a Bluetooth® connection. In addition, the wireless connection may employ a Radio Frequency Identification (“RFID”) communication including RFID standards established by the International Organization for Standardization (“ISO”), the International Electrotechnical Commission (“IEC”), the American Society for Testing and Materials® (ASTM®), the DASH7™ Alliance, and EPCGlobal™.

Alternatively, the wireless connection may employ a ZigBee® connection based on the IEEE 802 standard. In one embodiment, the wireless connection employs a Z-Wave® connection as designed by Sigma Designs®. Alternatively, the wireless connection may employ an ANT® and/or ANT+® connection as defined by Dynastream® Innovations Inc. of Cochrane, Canada.

The wireless connection may be an infrared connection including connections conforming at least to the Infrared Physical Layer Specification (“IrPHY”) as defined by the Infrared Data Association® (“IrDA”®). Alternatively, the wireless connection may be a cellular telephone network communication. All standards and/or connection types include the latest version and revision of the standard and/or connection type as of the filing date of this application.

The one or more servers 108, in one embodiment, may be embodied as blade servers, mainframe servers, tower servers, rack servers, and/or the like. The one or more servers 108 may be configured as mail servers, web servers, application servers, FTP servers, media servers, data servers, web servers, file servers, virtual servers, and/or the like. The one or more servers 108 may be communicatively coupled (e.g., networked) over a data network 106 to one or more information handling devices 102 and may be configured to execute or run machine learning algorithms, programs, applications, processes, and/or the like.

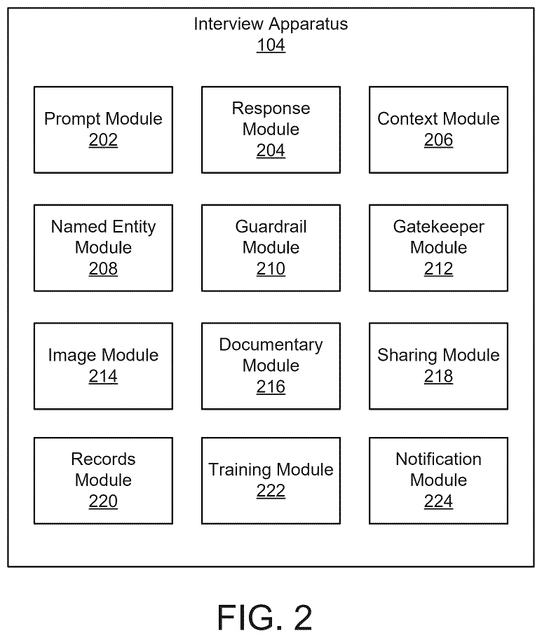

FIG. 2 depicts one embodiment of an apparatus for techniques for an AI assistant for family history and storytelling in accordance with the subject matter disclosed herein. In one embodiment, the apparatus includes an embodiment of an interview apparatus 104. In one embodiment, the interview apparatus 104 is configured as an AI-assisted interview system for conducting biographical interviews, enabling users to record their life stories, experiences, and memories in an interactive and engaging manner. The system employs artificial intelligence and natural language processing techniques to generate personalized follow-up questions, analyze user responses, and create comprehensive story summaries and memoirs.

In such an embodiment, the interview apparatus 104 may utilize a generative AI engine or model to create prompts for the user to respond to, to reason and analyze the user's responses, to generate family trees and other relationships based on the user's responses, and/or the like. As used herein, a generative AI is a type of AI that can create new content—such as text and images—based on patterns it has learned from existing data. It uses machine learning models, particularly deep learning techniques like neural networks, to generate outputs that resemble human-created content. Various other AI models, engines, platforms, or the like may be used.

In certain embodiments, the AI may be trained on a large dataset, such as a large dataset of genealogy information, census information, and/or various other types of data, to learn structures, patterns, and/or relationships in the data. The AI may be configured to generate prompts or questions to present to the user to elicit responses, e.g., long-form responses, short answers, single word answers, or the like, as it relates to the user's family, past, history, and/or the like.

For example, the prompt module 202 may trigger, signal, command, execute, or the like the AI to prompt the user with a general question such as “Tell me about your family,” or a more specific question such as “Tell me about a time when you went fishing with your father.” The response module 204 may receive the user's response to the question and use the AI to generate family tree relationships/connections and/or other relationships/connections, e.g., to a pet, to an object such as a car, to locations, and/or the like. Based on the user's responses, the AI may generate follow-up questions to get additional information from the user.

In one embodiment, the prompt module 202 is configured to present an initial prompt to a user. The initial prompt may include a prompt to begin or start a conversation, such as “tell my about your day,” “tell me about your 16^{th} birthday,” “what was your favorite vacation,” or the like. The prompt may be a text prompt, an audio prompt, a video prompt, or the like.

In one embodiment, the prompt module 202 may select the initial prompts or questions from a question bank, or may generate a prompt using the AI. However, once enough information has been captured, the prompt module 202 may use the AI to generate prompts or questions on the fly to capture information and direct a conversation towards a goal, e.g., capturing information about a particular event, about a person, about a photograph, and/or the like. In this manner, the AI takes a goal-oriented approach to elicit information from a user and avoid getting off-topic or presenting prompts that generate responses that are unrelated to the goal.

In such an embodiment, the AI may proceed in a certain tone or style, either by voice or text, e.g., in an emphatic, engaging interaction style. The prompt module 202 may configure the AI to dynamically adjust, change, or modify its style or tone based on its interactions with the user. For example, the AI may detect that the user is becoming nostalgic while relating a story and may adjust its tone accordingly, e.g., to be supportive and empathetic, or the AI may detect that the user is getting excited or laughing while telling a story and may adjust its style or stone to be more lighthearted, happy, or the like.

In one embodiment, the prompt module 202 receives an initial prompt from a user. For instance, the user may enter a prompt such as “I want to tell a story about the first time I went fishing with my dad,” or the like. Based on the user-provided prompt, the prompt module 202 may generate one or more additional prompts to direct the user through a conversation for telling the story, e.g., using the AI to generate the prompts based on the input from the user.

In one embodiment, the prompt module 202 configures the AI to generate prompts that are designed to capture certain data from the user in the user's responses. For example, prompts may be configured to capture the user's personal information, given names, surnames, sex, birth details (date and location), marriage details (date, location, and spouse information), death details (date and location), relationships, direct family relations (parents, siblings, children), marriage relationships and extended family, former spouses, step relationships, adoptive relationships, pet relationships, locations where the user lived, schools the user attended, friends, and/or the like.

The prompts, queries, questions, or the like may include atomic questions that include single, precise questions that are easy to answer (e.g., what is your name, who is your spouse, etc.). The prompt module 202 may configure the AI to generate prompts that are designed to enforce topic isolation (e.g., keeping topics distinct by adjusting parameters to avoid topic overlap and to maintain independence of topics).

In one embodiment, the prompt module 202 configures the AI to generate prompts or responses as part of a natural flow conversation. For instance, the AI may utilize context of the user's responses to generate relationship- or family tree-aware sequencing, to generate follow-up questions based on information that the user provides, or the like. The prompt module 202 may analyze the user's responses and provide prompts to confirm the accuracy of information (e.g., dates, relationships, names, or the like), to suggest corrections, and/or otherwise ensure that the data is consistent. In such an embodiment, the prompt module 202 may cross check information that the user provides with data already in the user's family tree to confirm that information is consistent, including names, (e.g., how the names are spelled), dates, locations, or the like. In one embodiment, the prompt module 202 enforces guardrails or other safety checks to ensure that the AI does not generate prompts that may be insensitive, obscene, or the like.

In one embodiment, the response module 204 is configured to receive a response to the prompt from the user. The response may be a text response, an audio response, a video response, an image, and/or the like that is received using a text input device (e.g., physical keyboard or on-screen keyboard), a microphone, a camera or video camera, or the like. The response module 204 may feed the responses to the AI for further training, prompt generation, context/content generation, and/or the like. For instance, the prompt module 202 may generate one or more additional prompts based on the user's response to the initial prompt to create, generate, map, design, plan, or the like, a conversation with the user using the AI.

In one embodiment, the interview apparatus 104, the prompt module 202, the response module 204, the AI, and/or the like, are configured with multilingual capabilities to support multiple different languages. In such an embodiment, the interview apparatus 104, the prompt module 202, the response module 204, the AI, and/or the like can process and generate content in multiple languages, allowing users to record their stories in their preferred language. In one embodiment, state-of-the-art machine translation and language understanding techniques are incorporated to ensure accurate transcription, analysis, and generation across different languages.

In one embodiment, the context module 206 is configured to generate contextual information based on responses to the one or more additional prompts using the AI. In one embodiment, the contextual information comprises a story, a summary, an outline, a title, commentary, or a combination thereof that the artificial intelligence engine generates based on responses to the initial prompt and the one or more additional prompts.

For instance, the context module 206 may take the user's responses to prompts and create a story, using the AI, by combining the user's responses into a narrative. For example, the AI may prompt the user with a series of questions about Christmas when the user was ten years old, e.g., who was there, presents that the user received, etc. The context module 206 may take the user's responses to generate a story for the user about that Christmas, e.g., using the AI, including pictures, images, or the like. The context module 206 may generate the story in various formats including text, hypertext markup language (HTML), or the like. In one embodiment, the context module 206 may use the AI to generate images, videos, audio, or other content to go with the story based on the user's responses and the associated story.

In one embodiment, the context module 206 is configured to create summaries of individual stories and comprehensive biographies that span multiple sessions and stories. The context module 206, in one embodiment, utilizes a list of predefined themes and topics, each associated with specific information extraction rules and AI-generated prompts. The context module 206, in one embodiment, analyzes the user's responses to identify the most relevant themes, and generates targeted prompts to gather additional details. The extracted information is then synthesized using the AI to create coherent and compelling summaries and biographies.

In one embodiment, the context module 206 may include third-party information, external data sources, third-party data sources, online data sources, and/or the like to supplement the user's responses and for incorporation into the story. For instance, the context module 206 may access census data records to find other relationships and information associated with the user, or the user's relationships, or may access historical newspapers and other records. In one embodiment, the context module 206 may extract contextual information from one or more other users associated with the user such as content provided by family, friends, colleagues, or the like. In this manner, the interview apparatus 104 can automatically fill in gaps, extend the user's family tree, enhance the user's stories with events (e.g., historical events, sporting events, or the like), and/or the like.

In one embodiment, the named entity module 208 is configured to identify people, places, events, dates, or a combination thereof associated with the user's responses. In such an embodiment, the named entity module 208 creates data structures that represent entities and relationships between the entities based on the user's responses to the AI-generated prompts. An entity, as used herein, may refer to a person, pet, object, thing, item, or the like that is related to the user. A relationship, as used herein, may refer to the connections between entities. In graph terminology, an entity is a node, and a relationship is an edge that connects two nodes together. The data structures may be formatted as structured data such as extensible markup language (XML), JavaScript Object Notation (JSON), or the like.

In one embodiment, the named entity module 208 may generate the entity relationships dynamically, in real-time, as the user provides responses to the AI-generated prompts. For instance, the named entity module 208 may create entity and relationship data for a family tree structure in response to the user telling a story about their family members or otherwise describing people in the user's family. In one embodiment, the named entity module 208 may generate a graphic, visualization, image, animation, or the like on an interface that shows the entity relationships, e.g., the user's family tree, during or after the user provides a response. In one embodiment, the named entity module 208 maps entities across different stories and sessions to establish connections and relationships between various aspects of the user's life story. This mapping process may enable the prompt module 202 to generate new initial prompts based on identified gaps or areas that require further exploration.

In one embodiment, the guardrail module 210 is configured to generate robust guardrails for maintaining a safe and respectful environment. In such an embodiment, the guardrail module 210 utilizes a proprietary database of offensive and non-offensive data, such as stories, summaries, and questions, to train and test the guardrails algorithms that the AI uses. The guardrail module 210 may provide user responses to the AI to be analyzed to flag potentially offensive content, which is then handled appropriately based on predefined rules and guidelines or user preferences. The guardrail module 210, in one embodiment, ensures that the generated follow-up questions and outputs remain respectful when handling sensitive or inappropriate topics. Further, as social norms and mores change over time, the guardrail module 210 retrains or refines the AI to account for changes in social norms and/or user preferences.

In one embodiment, the gatekeeper module 212 is configured to maintain a collection of user-specific facts and information, such as personal details, preferences, and previously shared stories. The gatekeeper module 212, in one embodiment, employs a “decision tree” approach to determine the appropriateness of certain questions based on the user's profile and history. For example, if a user has previously mentioned that they do not have children, the system may avoid generating prompts related to their experience as a parent.

In one embodiment, the image module 214 is configured to identify, locate, receive, or the like an image or video associated with the user, e.g., from the user, from social media, from newspapers, or the like, and configure the AI to present the image to the user and generate one or more prompts to elicit responses from the user related to the image. For instance, the AI may present the image and ask the user for information about who is in the image, what was happening in the image (e.g., tell a story about the image), and/or the like.

In one embodiment, the image module 214 implements, uses, employs, creates, or the like a multimodal transformer architecture, e.g., as part of the AI, to generate photo-specific prompts, encouraging users to provide more context and details about the images they share. The transformer considers the visual features of the photo and any surrounding text to generate relevant and engaging prompts.

In one embodiment, the documentary module 216 is configured to generate a documentary for the user based on the user's stories, family tree information, and other content. For instance, the documentary module 216 may take the user's stories and create an AI-generated documentary in the form of a video, film, slideshow, animation, or the like, of the user's life, of an event during the user's life, or the like. In such an embodiment, the documentary module 216 may configure the AI to generate voice-over or narration audio that syncs with the video or image being presented.

In one embodiment, the sharing module 218 is configured to enable users to share their stories with family members, friends, or colleagues. Invited collaborators can access shared stories, add their own responses, and provide additional context or perspectives. They can also ask their own follow-up questions, which the prompt module 202 will present to the original storyteller in a future recording session. Data shared between user accounts can help inform questions, fill in gaps, provide important or missing context, and enhance the overall completeness and efficiency of the data collection, recording, and output generation processes. In such an embodiment, the sharing module 218 fosters a sense of community and encourages the preservation of collective memories and experiences.

In one embodiment, the records module 220 is configured to allow users to upload or access relevant digital records such as genealogical relationships and family trees. The interview apparatus 104 can draw from this additional data to enhance generated questions with additional specificity, to avoid asking questions that can be answered without the user providing verbal input, or to create more comprehensive biographical outputs.

In one embodiment, the training module 222 is configured to train the AI on various data. In such an embodiment, the AI may be trained on a large dataset or corpus, such as a large dataset of genealogy information, census information, and/or various other types of data, to learn structures, patterns, and/or relationships in the data. The training module 222 may be configured to continuously or periodically retrain or refine the AI using feedback based on new data from the user, new external third-party data, and/or the like.

In one embodiment, the notification module 224 is configured to send notifications to the user as reminders, suggestions, recommendations, or the like for creating a new story. For instance, the notification module 224 may send push notifications, text messages, emails, or the like to remind the user to create a story about an event in the user's life or about one of various other topics. In one embodiment, the notification module 224 may have access to a photo or video sharing site for the user, to the user's social media pages, or the like and may detect when new content has been uploaded or posted and prompt the user to create a story about the new content.

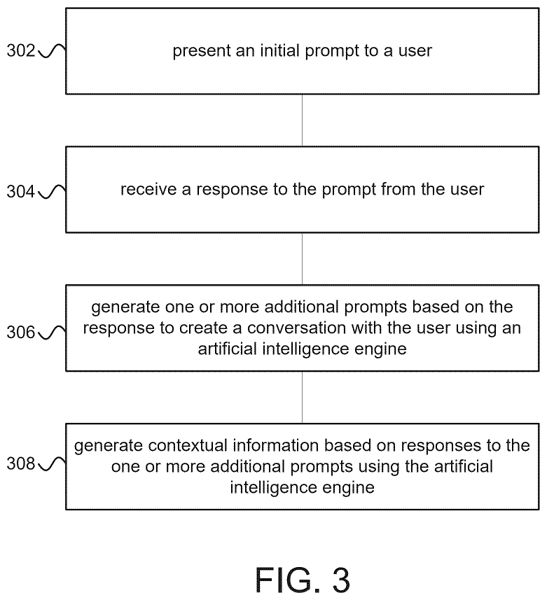

FIG. 3 is a schematic flow chart diagram illustrating one embodiment of a method for techniques for an AI assistant for family history and storytelling, in accordance with the subject matter disclosed herein. In one embodiment, the method may be performed by an information handling device 102, a server 108, an end-user device, an interview apparatus 104, and/or a combination thereof.

In one embodiment, the method begins and presents 302 an initial prompt to a user. In one embodiment, the method receives 304 a response to the prompt from the user. In one embodiment, the method generates 306 one or more additional prompts based on the response to create a conversation with the user using an artificial intelligence engine. In one embodiment, the method generates 308 contextual information based on responses to the one or more additional prompts using the artificial intelligence engine, and the method ends.

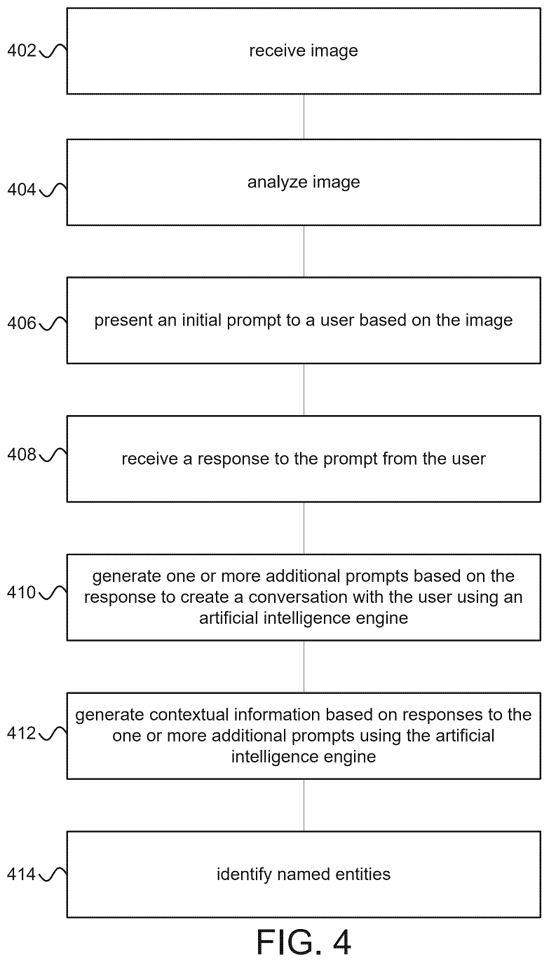

FIG. 4 is a schematic flow chart diagram illustrating one embodiment of a method for techniques for an AI assistant for family history and storytelling, in accordance with the subject matter disclosed herein. In one embodiment, the method may be performed by an information handling device 102, a server 108, an end-user device, an interview apparatus 104, and/or a combination thereof.

In one embodiment, the method begins and receives 402 an image, e.g., from a data storage location, from a user, or the like. In one embodiment, the method analyzes 404 the image, e.g., using AI and/or image processing techniques, to identify people, places, dates, objects, pets, and/or the like within the image. In one embodiment, the method presents 406 an initial prompt to a user based on the items identified in the image.

In one embodiment, the method receives 408 a response to the prompt from the user. In one embodiment, the method generates 410 one or more additional prompts based on the response to create a conversation with the user using an artificial intelligence engine. In one embodiment, the method generates 412 contextual information based on responses to the one or more additional prompts using the artificial intelligence engine, and the method ends. In one embodiment, the method identifies 414 named entities within the image and/or user responses, such as other people, pets, objects, and/or the like, and creates or updates relationships between the entities (e.g., within the underlying data structures), and the method ends.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in certain embodiments that may not be present in all embodiments.

These features and advantages of the embodiments will become more fully apparent from the following description and appended claims, or may be learned by the practice of embodiments as set forth hereinafter. As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

Many of the functional units described in this specification have been labeled as modules, in order to more particularly emphasize their implementation independence. For example, a module may be implemented as a hardware circuit comprising custom very large scale integrated (“VLSI”) circuits or gate arrays, off-the-shelf semiconductors such as logic chips, transistors, or other discrete components. A module may also be implemented in programmable hardware devices such as a field programmable gate array (“FPGA”), programmable array logic, programmable logic devices or the like.

Modules may also be implemented in software for execution by various types of processors. An identified module of program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the program code may be stored and/or propagated on in one or more computer readable medium(s).

Furthermore, embodiments may take the form of a program product embodied in one or more computer readable storage devices storing machine readable code, computer readable code, and/or program code, referred hereafter as code. The storage devices, in some embodiments, are tangible, non-transitory, and/or non-transmission.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (“ISA”) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider). In some embodiments, electronic circuitry including, for example, programmable logic circuitry, field-programmable gate arrays (“FPGA”), or programmable logic arrays (“PLA”) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods, and computer program products according to various embodiments of the present invention. In this regard, each block in the schematic flowchart diagrams and/or schematic block diagrams may represent a module, segment, or portion of code, which comprises one or more executable instructions of the program code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

The description of elements in each figure may refer to elements of proceeding figures. Like numbers refer to like elements in all figures, including alternate embodiments of like elements.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C. As used herein, “a member selected from the group consisting of A, B, and C and combinations thereof” includes only A, only B, only C, a combination of A and B, a combination of B and C, a combination of A and C or a combination of A, B and C.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An apparatus, comprising:
at least one memory; and
at least one processor coupled with the at least one memory and configured to cause the apparatus to:
present an initial prompt to a user;
receive a response to the prompt from the user;
generate one or more additional prompts based on the response to create a conversation with the user using an artificial intelligence engine; and
generate contextual information based on responses to the one or more additional prompts using the artificial intelligence engine.

2. The apparatus of claim 1, wherein the response is an audio response and the at least one processor is configured to cause the apparatus to transcribe the audio response prior to providing it to the artificial intelligence engine.

3. The apparatus of claim 1, wherein the at least one processor is configured to cause the apparatus to present a plurality of predefined prompts and receive a selection of the initial prompt from the plurality of predefined prompts.

4. The apparatus of claim 1, wherein the initial prompt is a user-generated prompt.

5. The apparatus of claim 4, wherein the user-generated prompt is based on information from the user or from a different user associated with the user, or a combination thereof.

6. The apparatus of claim 1, wherein the initial prompt is generated by the artificial intelligence engine based on previous responses and contextual information associated with the user.

7. The apparatus of claim 1, wherein the contextual information comprises a story, a summary, an outline, a title, commentary, or a combination thereof that the artificial intelligence engine generates based on responses to the initial prompt and the one or more additional prompts.

8. The apparatus of claim 1, wherein the at least one processor is configured to identify people, places, events, dates, or a combination thereof associated with the responses.

9. The apparatus of claim 1, wherein the at least one processor is configured to cause the apparatus to generate the one or more additional prompts based on a conversation theme and to guide the conversation toward the conversation theme.

10. The apparatus of claim 1, wherein the at least one processor is configured to cause the apparatus to receive an image and generate one or more prompts related to the image using the artificial intelligence engine.

11. The apparatus of claim 1, wherein the at least one processor is configured to:
identify third-party contextual information from one or more third party sources;
integrate the third-party contextual information into the contextual information; and
use the third-party contextual information to generate the one or more additional prompts.

12. The apparatus of claim 1, wherein the at least one processor is configured to extract contextual information from one or more other users associated with the user.

13. The apparatus of claim 1, wherein the artificial intelligence engine comprises a generative artificial intelligence engine.

14. The apparatus of claim 1, wherein the at least one processor is configured to continuously retrain the artificial intelligence engine based on the responses and contextual information.

15. A method, comprising:
presenting an initial prompt to a user;
receiving a response to the prompt from the user; and
generating one or more additional prompts based on the response to create a conversation with the user using an artificial intelligence engine; and
generating contextual information based on responses to the one or more additional prompts using the artificial intelligence engine.

16. The method of claim 15, wherein the response is an audio response and the method further comprises transcribing the audio response prior to providing it to the artificial intelligence engine.

17. The method of claim 15, further comprising presenting a plurality of predefined prompts and receive a selection of the initial prompt from the plurality of predefined prompts.

18. The method of claim 15, wherein the initial prompt is a user-generated prompt based on information from the user or from a different user associated with the user, or a combination thereof.

19. The method of claim 15, wherein the initial prompt is generated by the artificial intelligence engine based on previous responses and contextual information associated with the user.

20. A computer program product comprising a nontransitory computer readable storage medium storing code, the code being configured to be executable by a processor to perform operations comprising:
presenting an initial prompt to a user;
receiving a response to the prompt from the user; and
generating one or more additional prompts based on the response to create a conversation with the user using an artificial intelligence engine; and
generating contextual information based on responses to the one or more additional prompts using the artificial intelligence engine.
